(19) United States
(12) Patent Application Publication
(10) Pub. No.: US 2018/0239012 A1
(43) Pub. Date: Aug. 23, 2018

(54) ANTENNA WITH BORESIGHT OPTICAL SYSTEM

(71) Applicant: EDH US LLC, Orlando, FL (US)

(72) Inventor: Henri Johnson, Windermere, FL (US)

(21) Appl. No.: 15/894,464

(22) Filed: Feb. 12, 2018

Related U.S. Application Data
(63) Continuation of application No. 15/101,800, filed on Jun. 3, 2016, now abandoned.
(60) Provisional application No. 61/911,387, filed on Dec. 3, 2013.

(51) Int. Cl. G01S 13/86; G01S 13/42; G01S 7/40; G01S 13/44

(52) U.S. Cl. CPC G01S 13/867; G01S 13/42; G01S 7/4026; G01S 13/4445; G01S 2007/4034; G01S 2007/403; G01S 13/4454; G01S 13/4418

(57) ABSTRACT

Systems and methods to reduce parallax errors are provided for an antenna array having a boresight optical system. In an example embodiment, a method comprises constructing an antenna array having antenna elements disposed symmetrically around an antenna axis and providing an optical aperture in the antenna array. An optical instrument having an optical axis is arranged in or adjacent the optical aperture. A first portion of the antenna elements receives reflected signals from a target in flight. A second portion of the antenna elements receives reflected signals from the same target in flight. A direction of travel of the target is calculated based on an average of the respective signals received by the first and second portions of the antenna elements.

### RELATED APPLICATIONS

This application claims priority from U.S. Provisional Patent Application Ser. No. 61/911,387, filed Dec. 3, 2013, which is incorporated herein by reference in its entirety and made a part hereof.

### BACKGROUND

The present disclosure relates to an antenna with boresight optical system for parallax free measurement of nearby target positions.

The parallax caused by the offset in the angular measurements is negligible for distant targets. For nearby targets, the parallax causes angular errors in measurements taken by the optical instrument. Optical instruments like telescopes or cameras are often used as “boresight” instruments with directional radar antennas as a means to measure the direction of a target relative to the pointing (or reference) direction of the antenna. Such measurements can be used in calculating the spatial position and trajectory of a target, and provide angular tracking data for an antenna steering control system.

A common practice with boresight optical instruments is to align the optical axis accurately with the antenna's electromagnetic axis. The antenna's electromagnetic axis can typically be the direction of maximum amplitude response of the antenna. One common alignment method adjusts the mounting of the optical instrument so that the optical and electromagnetic axes are parallel. Practically, a calibration procedure is usually performed by using a distant reference target that provides both electromagnetic and optical reference positions. Alignment errors or offsets are be measured and removed through mechanical adjustments. Residual alignment offsets can also be recorded and used as correction factors when calculating target positions relative to the antenna pointing direction.

One problem with optical alignment instruments is that, for practical reasons, their optical axes are usually displaced parallel to and away from the antenna's electromagnetic axes. A center-fed parabolic antenna cannot for example accommodate an optical instrument without affecting the antenna's performance. Another example is a phased array comprising three antenna elements used for the simultaneous measurement of two orthogonal target directions. No common phase center exists for such an antenna arrangement.

The present inventor has recognized, among other things, the problems discussed above. The present disclosure can help provide solutions to these problems, such as by providing a symmetrical antenna array with a phase center that is precisely aligned with the optical axis of the optical instrument. This arrangement seeks to minimize parallax errors that might affect the location measurement of nearby targets.

### SUMMARY

In an example embodiment, a system comprises an antenna array having antenna elements disposed symmetrically around an antenna axis; an optical aperture disposed in the antenna array; an optical instrument having an optical axis arranged in or adjacent the optical aperture; and at least one processing device configured to process reflected signals received by respective first and second portions of the antenna elements from a target in flight; and calculate, though phase comparison or time-of-arrival methods, a direction of travel of the target based on the respective signals received by the first and second portions of the antenna elements. In some examples, the optical axis of the optical instrument is aligned with the antenna axis.

In some examples, the at least one processing device is further configured to determine an elevation or azimuth angle of the target relative to real-world coordinates or a reference direction. The at least one processing device may be further configured to derive a first elevation or azimuth angle of the target based on reflected signals received by the first portion of the antenna elements; derive a second elevation or azimuth angle of the target based on reflected signals received by the second portion of the antenna elements; and average the first and second elevation or azimuth angles to effectively cause the phase center of the respective angle measurements to be at the physical center of the antenna array in alignment with the optical axis of the optical instrument.

The at least one processing device may be further configured to calculate further target angles from successive segments of the received signals, to provide a time varying record of target angles.

The present disclosure also includes a non-transitory machine-readable medium containing instructions that, when read by a machine, cause the machine to perform operations comprising receiving, by a first portion of antenna elements, reflected signals from a target in flight; receiving, by a second portion of antenna elements, reflected signals from the target in flight; and calculating, though phase comparison or time-of-arrival methods, a direction of travel of the target based on the respective signals received by the first and second portions of the antenna elements. The step of calculating the direction of travel may include determining an elevation or azimuth angle for the target relative to real-world coordinates or a reference direction.

In some examples, the operations further comprise deriving a first elevation or azimuth angle of the target based on reflected signals received by the first portion of the antenna elements; deriving a second elevation or azimuth angle of the target based on reflected signals received by the second portion of the antenna elements; and averaging the first and second elevation or azimuth angles to effectively cause the phase center of the respective angle measurements to be at the physical center of the antenna array in alignment with the optical axis of the optical instrument. The operations may further comprise calculating further target angles from successive segments of the received signals, to provide a time varying record of target angles.

The present disclosure also includes methods for parallax free measurement of nearby target positions. One example method comprises assembling an antenna array having antenna elements disposed symmetrically around an antenna axis; providing an optical aperture in the geometric center of the antenna array; arranging an optical instrument having an optical axis in or adjacent the optical aperture; receiving, by a first portion of the antenna elements, reflected signals from a target in flight; receiving, by a second portion of the antenna elements, reflected signals from the target in flight; and calculating, though phase comparison or time-of-arrival methods, a direction of travel of the target based on the respective signals received by the first and second portions of the antenna elements.

The method may further comprise aligning the optical axis of the optical instrument with the antenna axis. Calculating the direction of travel may include determining an elevation or azimuth angle of the target relative to real-world coordinates or a reference direction.

In further examples, the method may further comprise deriving a first elevation or azimuth angle of the target using the first portion of the antenna elements; deriving a second elevation or azimuth angle of the target using the second portion of the antenna elements; and averaging the first and second elevation or azimuth angles to effectively cause the phase center of the respective angle measurements to be at the physical center of the antenna array in alignment with the optical axis of the optical instrument. The method may further comprise calculating further target angles from successive segments of the received signals, to provide a time varying record of target angles.

### DESCRIPTION OF THE DRAWINGS

The example embodiments may be better understood, and its numerous features and advantages made apparent to those skilled in the art by referencing the accompanying drawings and descriptions provided in the Detailed Description. For ease of understanding and simplicity, common numbering of elements within the illustrations is employed where an element is the same in different drawings. In the drawings, which are not necessarily drawn to scale, like numerals may describe similar components in different views. In some instances, different numerals may describe similar components in different views. Like numerals having different letter suffixes may represent different instances of similar components. The drawings illustrate generally, by way of example, but not by way of limitation, various embodiments discussed in the present document.

FIG. 1 is a schematic view of an antenna array, according to an example embodiment.

FIG. 2 illustrates an antenna array having a boresight optical system, according to example embodiments.

FIG. 3 illustrates further aspects of an antenna array having a boresight optical system, according to example embodiments.

FIG. 4 is a block diagram of a machine in the example form of a computer system within which a set of instructions may be executed for causing the machine to perform any one or more of the methodologies herein discussed.

### DETAILED DESCRIPTION

The following is a detailed description of illustrative embodiments of the present invention. As these embodiments of the present invention are described with reference to the aforementioned drawings, various modifications or adaptations of the methods and or specific structures described may become apparent to those skilled in the art. All such modifications, adaptations, or variations that rely upon the teachings of the present inventions, and through which these teachings have advanced the art, are considered to be within the spirit and scope of the present invention. Hence, these descriptions and drawings are not to be considered in a limiting sense, as it is understood that the present invention is in no way limited to the embodiments illustrated.

The present disclosure relates to parallax free alignment and use of a boresight optical system with the electromagnetic axis of a directional antenna. The parallax caused by the offset in the angular measurements is typically negligible for distant targets. For nearby targets, the parallax causes angular errors in measurements taken by the optical instrument. Optical instruments like telescopes or cameras are often used as “boresight” instruments with directional radar antennas as a means to measure the direction of a target relative to the pointing direction of the antenna. Such measurements can be used in calculating the spatial position of the target, and provide angular tracking error data for an antenna steering control system.

A common practice with boresight optical instruments is to align the optical axis accurately with the antenna's electromagnetic axis. The antenna's electromagnetic axis can typically be the direction of maximum amplitude response of the antenna. One common alignment method adjusts the mounting of the optical instrument so that the optical and electromagnetic axes are parallel. Practically, a calibration procedure is usually performed by using a distant reference target that provides both electromagnetic and optical reference positions. Alignment errors or offsets are be measured and removed through mechanical adjustments. Residual alignment offsets can also be recorded and used as correction factors when calculating target positions relative to the antenna pointing direction.

As discuss further above, one common problem with optical alignment instruments is that, for practical reasons, their optical axes are usually displaced away from the antenna electromagnetic axes and therefore the axis of the optical instrument is not aligned or coincident with the axis of the antenna. This introduces a parallax error whose effect is especially prominent for nearby targets.

The present disclosure seeks to address at least this problem by arranging an antenna array symmetrically around the optical axis of an optical instrument, and combining the antenna measurements in a way that effectively makes the antenna phase center coaxial with the optical instrument. This arrangement differs from conventional arrangements. In the present arrangement, the boresight axes of the optical instrument and the antenna can be aligned at any distance with virtually no parallax effect caused by the offset between the axes of the antenna and the optical instrument when set up conventionally. As a result, the optical instrument and the antenna has negligible parallax errors for nearby targets.

A conventional antenna used with an optical alignment aid in which the optical instrument is not configured to be on or in the antenna's phase center will suffer alignment errors, especially when pointing towards or tracking nearby targets. In the present arrangement, a symmetrical antenna array is created with a phase center that is precisely aligned with the optical instrument, with substantially no significant parallax error that might affect nearby targets or calibration systems. In some example embodiments, the systems and methods of the present disclosure are used in Doppler radar based systems for tracking sports balls.

One example system of the present disclosure generally includes an antenna, an optical pointing instrument, means to mount and adjust the optical instrument, a receiver system or processing device, an optical processor and display, a data storage system for offset data storage, an output system to display or transmit direction measurements to users or other systems, and a reference target for calibration or electromagnetic and optical axes.

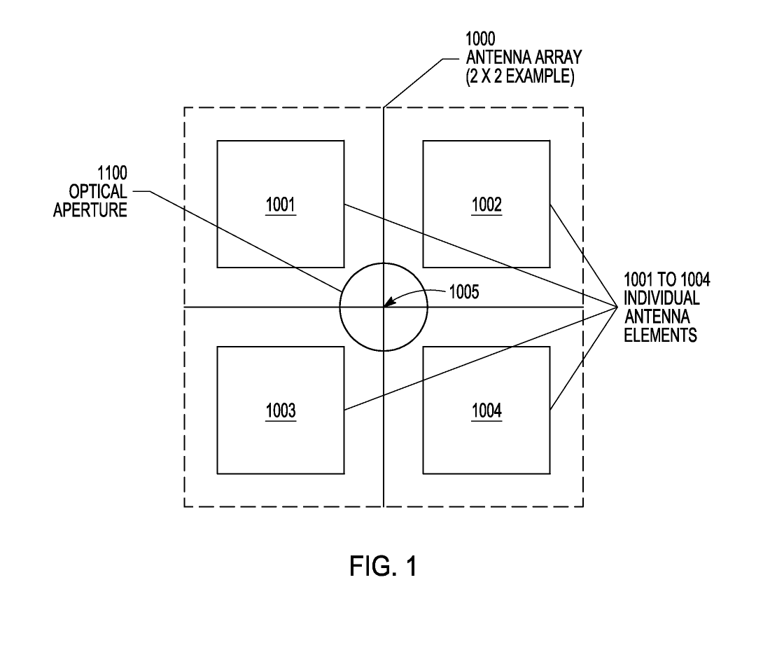

Referring now to FIG. 1 of the accompanying drawings, an antenna array 1000 comprises an array of antenna elements 1001, 1002, 1003 and 1004 arranged symmetrically around a center point 1005 where an optical aperture 1100 is located around the center point 1005. An antenna axis extends orthogonally from the page through center point 1005.

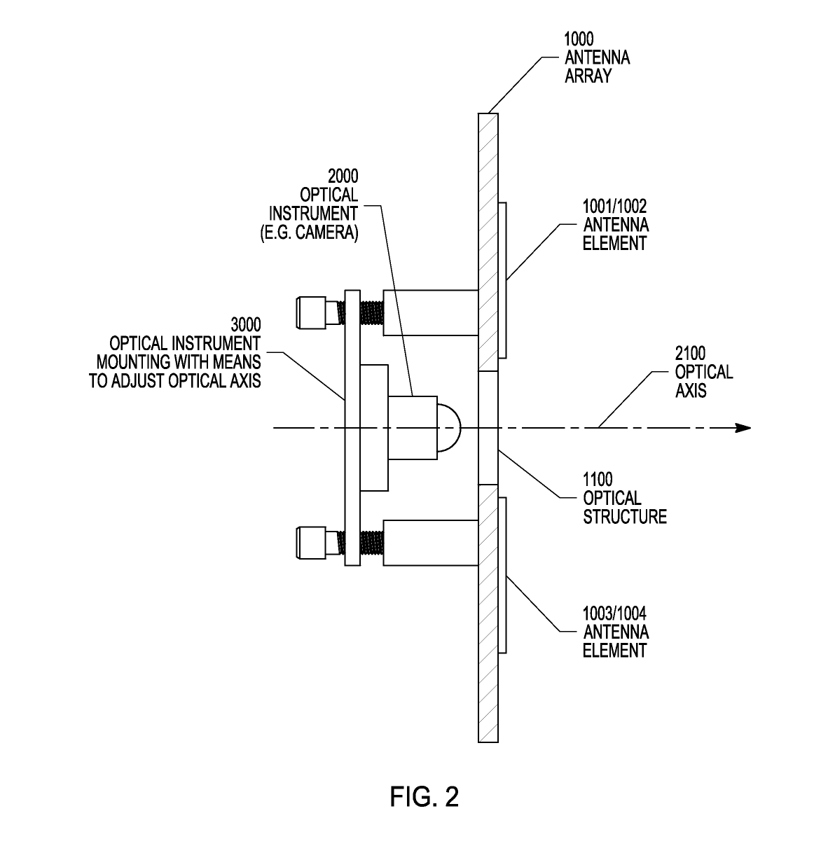

In FIG. 2 of the accompanying drawings, an optical instrument 2000, such as a telescope or a camera, is mounted adjacent the antenna array 1000 such that an optical axis 2100 of the optical instrument 2000 is coincident with the antenna axis extending through the center point 1005. A preferred mounting position of the optical instrument 2000 is (as shown) closely adjacent the antenna array 1000 such that the bulk or structure of the optical instrument 2000 will not interfere with the functioning of the antenna array 1000.

In the example arrangement shown in FIG. 2 of the accompanying drawings, the optical instrument 2000 is mechanically fixed to the antenna array 1000, and a mounting 3000 provides a means to adjust the optical axis 2100 during alignment calibration. An antenna receiving system (not shown) and an optical processing and display system (not shown) can be located together or separately, in an operating position near or away from the antenna array 1000. These components can for example be connected to the antenna array 1000 and the optical instrument 2000 by means of wired or wireless data interfaces.

Data storage devices as well as output displays and data interfaces can be incorporated in the example systems discussed herein, and such systems can be implemented at least partly on a personal computer, tablet computer, or smart phone device. In further aspects, a calibration jig can be used to align the optical and antenna axes of a constructed antenna array 1000 with the optical instrument 2000. This jig is not strictly necessary as part of the initial set up or calibration of these system components, but can be used once or occasionally to align the optical and electromagnetic axes of the system, as required.

In configuring the present antenna and boresight optical system, the antenna elements are geometrically arranged in an array 1000 to meet design requirements such as antenna gain, beam width and secondary lobes, while at the same time leaving or providing an aperture 1100 in the center of the array for an optical instrument 2000 such as a digital or movie camera, or a telescope. The antenna array is symmetrical, for example in a matrix of two by two (2×2) elements (see FIG. 1, for example). Other symmetrical configurations can also be constructed. The antenna elements can be realized as micro-stripline antennas, horns, dipoles, slots, or any other feasible method of making an antenna.

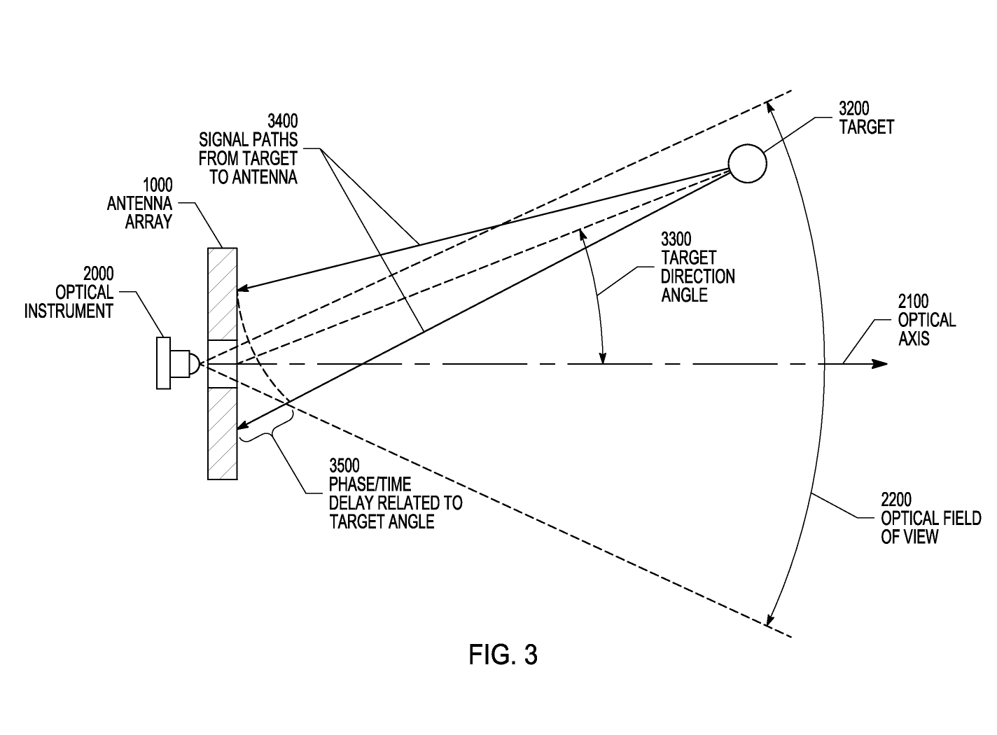

With reference now to FIG. 3, a direction of a target 3200 relative to the boresight direction (or optical axis, 2100) of an antenna array 1000 can be determined by measuring a time lag (shown generally at 3500) between signals reflected from the target 3200 arriving along different signal paths 3400. With the antenna elements 1001-1004 arranged with reference to real world coordinates (for example side-by-side horizontally and above-and-below vertically), the direction of the target 3200 can be measured as an elevation angle (for example, in a vertical plane 3300 in the view) and as an azimuth angle (in a horizontal plane).

With the antenna array 1000 set up in a symmetrical configuration, for example a 2×2 array shown in FIG. 1, the target's elevation angle 3300 is first measured by a pair of antenna elements in one portion of the array (for example, in the left section of the array such as elements 1001 and 1003 in FIG. 1) and another measurement is taken by the pair of elements in another or opposed portion of the array (for example, in the right section of the array such as elements 1002 and 1004 in FIG. 1) on the other side of antenna center 1005. Similarly the azimuth angle is measured by each of the pairs of horizontal antenna elements. Then the average values are calculated for each pair of antenna elements (e.g. 1001/1003 and 1002/1004) to provide a final measurement of elevation and azimuth angles respectively. The averaging of values causes the phase center of the respective angle measurements to be at the physical center 1005 of the antenna array 1000 and, because this is where the optical instrument 2000 is located (or more specifically where the optical axis 2100 is located), the radar angles (i.e. elevation and azimuth angles) are derived relative to the optical instrument axis 2100 and this, in effect, negates or at least minimizes parallax-induced errors.

Some embodiments of the present inventive subject matter include methods for parallax free measurement of nearby target positions. The disclosed methods also include methods of assembling and operating an antenna array having a boresight optical system as described herein. These method embodiments are also referred to herein as “examples.” Such examples can include method elements in addition to those shown or described. However, the present inventor also contemplates examples in which only those method elements shown or described are provided. Moreover, the present inventors also contemplate examples using any combination or permutation of those method elements shown or described above (or one or more aspects thereof), either with respect to a particular example (or one or more aspects thereof), or with respect to other examples (or one or more aspects thereof) shown or described herein.

A series of system assembly steps includes constructing an antenna array 1000 with elements 1001, 1002, 1003, and 1004 arranged symmetrically around an optical aperture 1100 in the center of the array 1000. The array 1000 may be arranged for example in 2 rows of 2 elements, making a 2×2 matrix. Arranging the orientation of the elements relative to real world coordinates (e.g. horizontal and vertical) will simplify target direction angle measurements.

The assembly steps further include mounting the optical instrument 2000 (which can be a digital camera with a suitable lens) to or adjacent the antenna array 1000 to provide a field of view achievable or desired behind the antenna array (e.g. as shown in FIG. 3). The optical axis 2100 is aligned with the center of the antenna array 1000. The mounting step should allow adjustment of the optical axis 2100 during alignment calibration.

A multi-channel receiver system can be incorporated into the optical system to detect and amplify signals received (e.g. via signal paths 3400, FIG. 3) by each antenna element from the target 3200. The received signals can be converted from analog to digital form so that further processing can be done by numerical analysis.

In further steps, the receiver system is programmed to calculate, through phase comparison or time-of-arrival methods (e.g. 3500 in FIG. 3), the direction of the target from a segment of the signals received by each chosen pair of antenna elements. In a 2×2 antenna array, the left and right side vertical pairs produce two measurements of the target elevation angle, and the top and bottom horizontal pairs provide two measurements of the target azimuth angle.

The receiver system then calculates the average of the two elevation angles, and the average of the two azimuth angles. These values become the final measurements target elevation and azimuth angle at the time corresponding to the signal segment that was processed.

The process continues to calculate further target angles from successive segments of the received signals, to provide a time varying record of target angles. This process may be performed in real time, while a target is being observed or tracked, or by post-processing a record of signals. Target angles calculated in the above manner are derived relative to the axis of the optical instrument on the antenna assembly. If the optical instrument was used to point the antenna in a particular direction the target angle measurements can be compared to this pointing direction.

If the target distance (range) is also measured (using a conventional range finding method for example), the target's spatial position and trajectory (if it is moving) can still be determined relative to real world objects, and not only in the antenna coordinate frame. One way of operating the present disclosure is in association with a non-moving antenna array of the type described herein to track a projectile's launch and flight trajectory. Specifically, before the projectile is launched, the antenna array can be pointed along a chosen direction and elevation angle. By virtue of the advantages derived by the present system, the antenna array can be located close to the launch position of the projectile and be pointed along a line through the launch position without parallax induced errors. An example of where this can be practically applied is in association with a golf ball or golf club tracking radar antenna array in which the launch position of the projectile can be as close as 6 to 8 feet from the antenna array. The present disclosure can thus provide a Doppler radar based tracking device for sports balls with the ability to make parallax free measurements of target directions.

Other applications of the present disclosure include instances in which the antenna array is moving, and the target is launched from near the antenna location or passes by in close proximity. The present subject matter may also conveniently allow alignment of an antenna array and optical instrument in a restricted space.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures usually require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

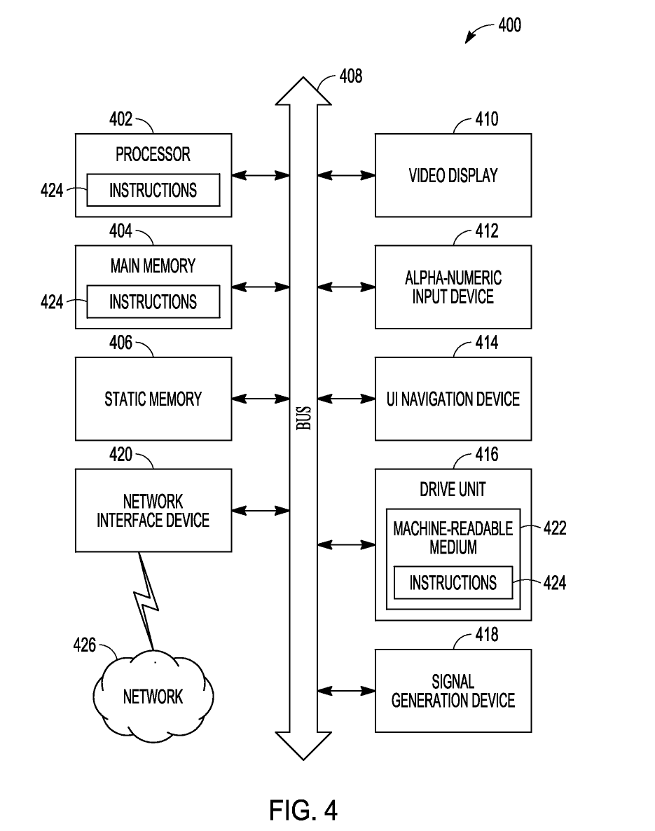

FIG. 4 is a block diagram of machine in the example form of a computer system 400 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 3402 (e.g., a central processing unit (CPU), a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard), a user interface (UI) navigation or cursor control device 414 (e.g., a mouse), a disk drive unit 416, a signal generation device 418 (e.g., a speaker) and a network interface device 420.

The disk drive unit 416 includes a machine-readable medium 422 on which is stored one or more sets of data structures and instructions 424 (e.g., software) embodying or utilized by any one or more of the methodologies or functions described herein. The instructions 424 may also reside, completely or at least partially, within the main memory 404 and/or within the processor 402 during execution thereof by the computer system 400, with the main memory 404 and the processor 402 also constituting machine-readable media.

While the machine-readable medium 422 is shown in an example embodiment to be a single medium, the term “machine-readable medium” may include a single medium or multiple media (e.g., a centralized or distributed database, and/or associated caches and servers) that store the one or more data structures or instructions 424. The term “machine-readable medium” shall also be taken to include any tangible medium that is capable of storing, encoding, or carrying instructions for execution by the machine and that cause the machine to perform any one or more of the methodologies of the embodiments of the present invention, or that is capable of storing, encoding or carrying data structures utilized by or associated with such instructions. The term “machine-readable medium” shall accordingly be taken to include, but not be limited to, solid-state memories and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 424 may further be transmitted or received over a communications network 326 using a transmission medium. The instructions 424 may be transmitted using the network interface device 420 and any one of a number of well-known transfer protocols (e.g., HTTP). Examples of communication networks include a LAN, a WAN, the Internet, mobile telephone networks, Plain Old Telephone (POTS) networks, and wireless data networks (e.g., Wi-Fi™ and WiMax™ networks). The term “transmission medium” shall be taken to include any intangible medium that is capable of storing, encoding or carrying instructions for execution by the machine, and includes digital or analog communications signals or other intangible media to facilitate communication of such software.

While the invention has been described with reference to specific embodiments, it will be understood by those skilled in the art that various changes may be made and equivalents may be substituted for the elements thereof without departing from the true spirit and scope of the invention. In addition, modifications may be made without departing from the essential teachings of the invention. Moreover, each of the non-limiting examples described herein can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method comprising:
assembling an antenna array having antenna elements disposed symmetrically around an antenna axis;
providing an optical aperture in the geometric center of the antenna array;
arranging an optical instrument having an optical axis in or adjacent the optical aperture;
receiving, by a first portion of the antenna elements, reflected signals from a target in flight;
receiving, by a second portion of the antenna elements, reflected signals from the target in flight; and
calculating, through phase comparison or time-of-arrival methods, a direction of travel of the target based on the respective signals received by the first and second portions of the antenna elements, the calculating of the direction of travel including:
determining a first and a second elevation or azimuth angles of the target relative to real-world coordinates or a reference direction, and
averaging the first and the second elevation or azimuth angles to effectively cause the phase center of the respective angle measurements to be at the physical center of the antenna array in alignment with the optical axis of the optical instrument.

2. The method of claim 1, further comprising:
aligning the optical axis of the optical instrument with the antenna axis.

3. (canceled)

4. The method of claim 1, further comprising:
deriving the first elevation or azimuth angle of the target using the first portion of the antenna elements; and
deriving the second elevation or azimuth angle of the target using the second portion of the antenna elements.

5. The method of claim 4, further comprising calculating further target angles from successive segments of the received signals, to provide a time varying record of target angles.

6. A system comprising:
an antenna array having antenna elements disposed symmetrically around an antenna axis;
an optical aperture disposed in the antenna array;
an optical instrument having an optical axis arranged in or near the optical aperture; and
at least one processing device configured to:
process reflected signals received by respective first and second portions of the antenna elements from a target in flight; and
calculate, through phase comparison or time-of-arrival methods, a direction of travel of the target based on the respective signals received by the first and second portions of the antenna elements, the calculating of the direction of travel including:
determining a first and a second elevation or azimuth angles of the target relative to real-world coordinates or a reference direction, and
averaging the first and the second elevation or azimuth angles to effectively cause the phase center of the respective angle 19 measurements to be at the physical center of the antenna array in alignment with the optical axis of the optical instrument.

7. The system of claim 6, wherein the optical axis of the optical instrument is aligned with the antenna axis.

8. (canceled)

9. The system of claim 6, wherein the at least one processing device is further configured to:
derive the first elevation or azimuth angle of the target using the first portion of the antenna elements; and
derive the second elevation or azimuth angle of the target using the second portion of the antenna elements.

10. The system of claim 9, wherein the at least one processing device is further configured to calculate further target angles from successive segments of the received signals, to provide a time varying record of target angles.

11. A non-transitory machine-readable medium containing instructions that, when read by a machine, cause the machine to perform operations comprising:
receiving, by a first portion of antenna elements, reflected signals from a target in flight;
receiving, by a second portion of antenna elements, reflected signals from the target in flight; and
calculating, though phase comparison or time-of-arrival methods, a direction of travel of the target based on the respective signals received by the first and second portions of the antenna elements, the calculating of the direction of travel including:
determining a first and a second elevation or azimuth angles of the target relative to real-world coordinates or a reference direction, and
averaging the first and the second elevation or azimuth angles to effectively cause the phase center of the respective angle 19 measurements to be at the physical center of the antenna array in alignment with the optical axis of the optical instrument.

12. (canceled)

13. The medium of claim 12, wherein the operations further comprise:
deriving the first elevation or azimuth angle of the target using the first portion of the antenna elements; and
deriving the second elevation or azimuth angle of the target using the second portion of the antenna elements.

14. The medium of claim 13, wherein the operations further comprise calculating further target angles from successive segments of the received signals, to provide a time varying record of target angles.
